(19) United States
(12) Patent Application Publication
(10) Pub. No.: US 2010/0212691 A1
(43) Pub. Date: Aug. 26, 2010

(54) POWER WASHDOWN FOR DEEP FRYER SYSTEM

(75) Inventors: Henry Preston Hutson, Bossier City, LA (US); Lane Langford, Bethany, LA (US)

Correspondence Address: OHLANDT, GREELEY, RUGGIERO & PERLE, LLP, ONE LANDMARK SQUARE, 10TH FLOOR, STAMFORD, CT, 06901, US

(73) Assignee: FRYMASTER L.L.C.

(21) Appl. No.: 12/708,912

(22) Filed: Feb. 19, 2010

Related U.S. Application Data
(60) Provisional application No. 61/208,100, filed on Feb. 20, 2009.

(51) Int. Cl. B08B 3/00

(52) U.S. Cl. 134/10; 134/111

(57) ABSTRACT

A washing system for a deep fryer having a fryer pot including a pump, a fryer pot having at least one port that is in fluid communication with the pump; and a valve in fluid communication with the one port and the pump. The system further comprising a diverter affixed to wall and disposed interiorly of the port that deflects fluid projecting from the at least one port against the wall. The system has a controller system that sends a signal to commence a filtration cycle for the frypot to thereby open the valve and provide access to fluid from said pump through the port to thereby clean a wall of the fryer pot. Each diverter is shaped to deflect oil released from the port against the wall to which it is affixed.

### CROSS-REFERENCE TO RELATED APPLICATION

This application claims the benefit of U.S. Provisional Application No. 61/208,100 filed on Feb. 20, 2009, which is incorporated by reference herein.

### BACKGROUND OF THE INVENTION

1. Field of the Invention

This disclosure relates to deep fryers for the food service industry. More particularly, this disclosure relates to a washing system for deep fryer frypots that use freshly filtered oil from strategically placed ports and diverters to wash food debris from the sides of frypots.

2. Description of Related Art

Deep fryers are commercially used by restaurants, institutional kitchens, and fast food establishments for cooking a variety of food products, such as french fries, fish, fried chicken, and the like. The food product is cooked by total immersion within a vat or tank that is filled with heated oil or shortening. Food particles tend to accumulate at the bottom and sides of the frypot during use. After the frypot is drained, a spray port is manually or automatically used to project a sheet of shortening in order to rinse food particles from the bottom and sides of the frypot.

Tube fryers and open frypots are often difficult to clean due to their depth, height and the cold zone areas. The frypot bottom typically is formed with a crease or fold extending from the back to the front of the vat, providing a funneling effect and allowing the shortening to collect and flow to a drain centrally located in the bottom of the vat. Manual systems incorporated into frypots for washing the sediment from the frypot are in a faucet style configuration located at either the top or the bottom of the fryer pot. These systems do not effectively clean sediment from the inner surface of the frypot in the absence of manual intervention.

Accordingly, a washdown system for the frypots of deep fryers is needed that uses strategically placed ports and diverters and a particular spray sequence to spray clean oil from the filtration system over the front, sides and bottom of a frypot.

### SUMMARY OF THE INVENTION

The present disclosure provides for a power washing system for a deep fryer frypot that uses strategically located oil ports that each has a diverter that projects oil in a spray pattern to wash frying sediment and debris from the front, rear, sides and bottom of the frypot.

The present disclosure also provides for a power washing system for a deep fryer frypot that uses a plurality of strategically located oil ports that each has a diverter to wash frying sediment and debris from the front, rear, sides and bottom of the frypot.

The present disclosure further provides for a power washing system for a deep fryer frypot that uses a control system including a controller, a manual interface board (MIB) and an Automatic Intermittent Filtration board (AIF) to monitor the operation a pump and valves associated with the ports in a predetermined sequence to wash sediment and debris from the front, bottom and sides of a frypot using oil that is projected from oil ports and deflected by diverters onto surfaces of the fryer pot.

The present disclosure further provides for a power washing system for a deep fryer frypot that uses a controller to monitor the operation a pump and valves associated with the ports in a predetermined sequence to wash sediment and debris from the front, bottom and sides of a frypot using oil that is projected from oil ports and deflected by diverters onto surfaces of the fryer pot. The present disclosure provides for a fryer pot that uses shaped diverters disposed over oil outlets on walls of the fryer pot such that oil contacting such diverters from outlets occurs at approximately a 90 angle and such oil is sprayed over a wall of the fryer pot on which such diverter is disposed.

The present disclosure still further provides for a method of power washing sediment and debris from a frypot using freshly filtered oil. A controller sends a signal to a drain valve to open and drain used cooking oil from a fryer pot. The controller then sends a signal to valves associated with front of fryer pot to open and a pump is sent a signal to commence pumping clean oil through valve associated with front of fryer pot for a pre-determined length of time. After the predetermined length of time elapses, the controller sends a signal to side valves to open, and sends a signal to front valves to close. Pump provides oil through side valves for a predetermined length of time. After the predetermined length of time elapses, control sends signal to rear return valve to open, and sends a signal to side valves to close, and pumps oil through rear return valve to wash all debris collected at bottom of frypot out drain. The controller sends a signal to drain valve to close for a filling operation to commence.

A washing system for a deep fryer having a fryer pot including a pump, a fryer pot having at least one port that is in fluid communication with the pump; and a valve in fluid communication with the one port and the pump. The system further comprising a diverter affixed to wall and disposed interiorly of the port that deflects fluid projecting from the at least one port against the wall. The system has a controller system that sends a signal to commence a filtration cycle for the frypot to thereby open the valve and provide access to fluid from said pump through the port to thereby clean a wall of the fryer pot.

A method of washing a fryer pot of a deep fryer, the fryer pot having four walls and a bottom, a pump a drain, a drain valve, a motor for placing the drain valve in an opened position or a closed position, a return port, a return valve and a motor for placing the return valve in an opened or closed position. The fryer pot also has provides that two of the four walls are opposed side walls each having at least one side port and a side valve in fluid communication with the side port, and one of said walls is a front wall that has at least one port and a valve in fluid communication with the front port. The method of washing includes opening the drain valve for a preset length of time; opening one of the front valve or the side valve for a preset length of time and providing oil through one of the front valve or the side valve. The method further provides for closing one of the front valve or the side valve; and closing the drain valve to fill the fryer pot.

### BRIEF DESCRIPTION OF THE DRAWINGS

The foregoing and still other objects and advantages of the present invention will be more apparent from the following detailed explanation of the preferred embodiments of the invention in connection with the accompanying drawings.

FIG. 1 illustrates a front perspective view of a deep fryer having frypots, according to the present disclosure;

FIG. 2 illustrates a rear perspective view of the deep fryer of FIG. 1, according to the present disclosure;

FIG. 3 illustrates a front view of the deep fryer of FIG. 1, without a cover, according to the present disclosure;

FIG. 4 illustrates a side view of the deep fryer of FIG. 1, without a cover according to the present disclosure;

FIG. 5 illustrates a front perspective view of the frypot of FIG. 1, according to the present disclosure;

FIG. 6 illustrates a top view of the frypot of FIG. 1, according to the present disclosure;

FIG. 7 illustrates a front view of the frypot of FIG. 1 according to the present disclosure;

FIG. 8 illustrates a side view of a frypot of a FIG. 1, according to the present is disclosure;

FIGS. 9a through 9d, illustrate a perspective, top, front, and side view respectively, of a diverter according to the present disclosure;

FIGS. 10a through 10d, illustrate a perspective, top, front, and side view respectively, of an alternative diverter according to the present disclosure; and

FIG. 11 illustrates schematic wiring diagram of a control system according to the present disclosure.

### DETAILED DESCRIPTION OF THE PREFERRED EMBODIMENT

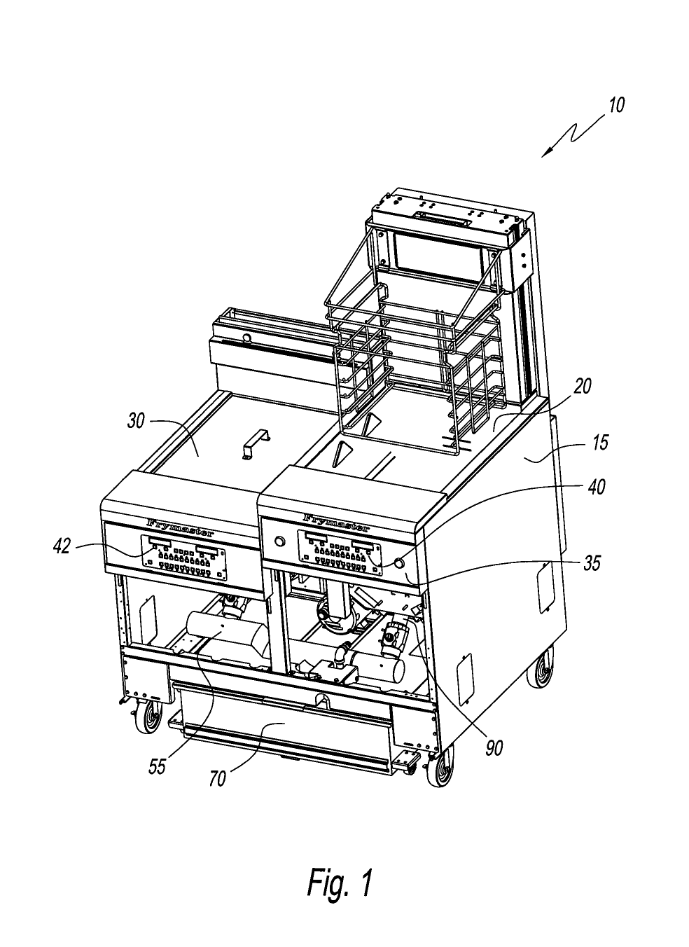

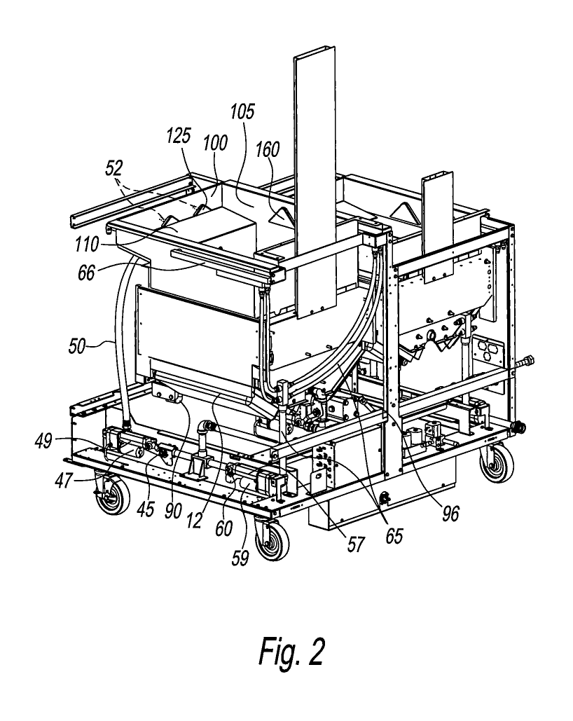

Referring to FIGS. 1 and 2, a front perspective view of a deep fryer is shown, and generally referred to by reference numeral 10. Deep fryer 10 has a housing 15 and two frypots 20 and 30. Frypots 20 and 30 contain oil for deep frying foods commonly used in the commercial food industry. Deep fryer 10 has burners 12 disposed on lower side to heat cooking oil. Each frypot 20 and 30 has a dedicated controller, 40 and 42 (not shown), respectively, a control panel 35 with a keypad, for communicating input from an operator for storage in a memory unit of controller 40 and 42, respectively, to control the function of frypots 20 and 30. Deep fryer 10 may also have a global controller to manage both controller 40 and 42. Deep fryer housing is shown as having two frypots 20 and 30; however, deep fryer 10 could have as many as four or six frypots. Frypots 20 and 30 are preferably high oil volume frypots with a V-shaped bottom that are sized to hold 75 or 105 gallons of cooking oil or shortening for large cooking operations.

FIGS. 1 through 4 show plumbing of deep fryer 10. Frypots 20 and 30 of each has the same components and function. Accordingly, the components and function of frypot 20 will only be referenced for purposes of simplicity. Frypot 20 has a drain 90, a drain manifold 55 to receive used cooking oil that is to be filtered, and a filter pan 70. Pump 80 having pump motor 81 are able to return clean oil to frypot 20 after it has been cleaned by filtration system components.

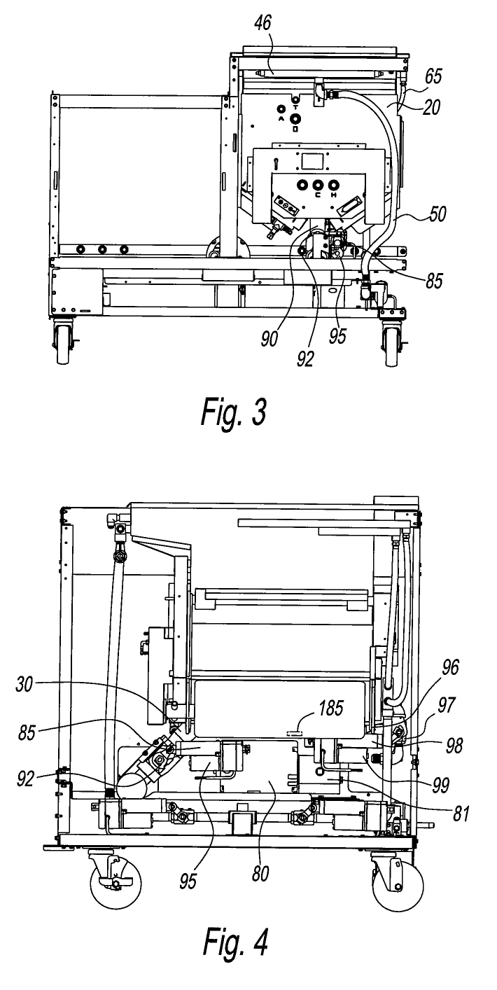

FIGS. 2 and 3 show a front washdown valve 45 that is in fluid communication with tubing 50 that supplies clean oil to front manifold 46. Oil flows through manifold 46 to front side ports 52. Each front side port 52 each has an associated diverter 125 disposed against front wall 100. Front wall 100 has a front deck 110 disposed beneath diverters 125. Valve 45 is opened or closed by motor 47 that drives linear actuator 49 when a signal is provided to motor 47 from controller 40 to drive actuator 49.

Referring to FIGS. 2, 4, and 5, a side washdown valve 60 is in fluid communication with tubing 65 that supplies clean oil to manifold 66. Oil is pumped from manifold 66 to side ports 75 disposed on opposite sides of fryer pot 20. Each side port 75 has an associated diverter 160 disposed against side wall 105. Valve 60 is opened or closed by motor 59 and liner actuator 57 when a signal is provided to motor 59 from controller 40 to drive actuator 57.

In FIGS. 1 through 4, a drain 90 has a drain valve 92, and motor 95 and an actuator 85. Drain valve 92 is opened or closed by motor 95 and actuator 85 when motor 95 receives signal to drain oil. Drain 90 is disposed at an angle of approximately 45° relative bottom edge of frypot 20. Frypot 20 also has a rear return 96 that receives clean or filtered oil that is supplied by pump 80 from filter pan 70. Rear return 96 has a valve 97 and a motor 98 and an actuator 99. Valve 97 is opened and or closed by motor 98 and actuator 99 when a signal is received from controller 40.

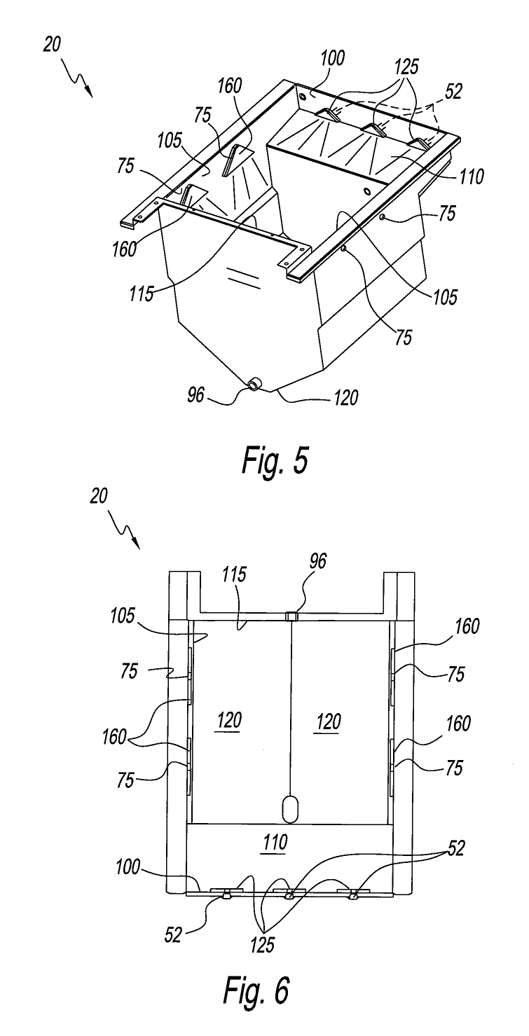

Referring to FIGS. 1 through 5, three front diverters 125 are shown. Frypot 20 has three front side ports 52 disposed on front wall 105. Front ports 52 each is receives clean oil from when valve 45 is opened and pumped through tubing 50. Clean oil is distributed to front side ports 52 from front manifold 46. Each port 52 has a diverter 125 affixed to front wall 100. Each diverter 125 is disposed inboard or interiorly of a respective port 52 to deflect oil that is received from pump 80 under pressure. Similarly, each diverter 125 is disposed interiorly of frypot 20 As oil is sprayed from ports 52, diverters 125, deflect clean oil in a downward direction to wash front wall 100 and foam deck 110. Diverters 125 are shaped and positioned to fan sprayed oil from ports 52 in a downward direction. The diverter shapes will be discussed further below. Clean oil is discharged from ports 52 at a 90° angle and strikes diverter 125 also at a 90° angle. The spray pattern of deflected oil is shown in FIG. 5 by arrows.

Referring to FIGS. 2 and 5, four lateral ports 75 on lateral sides 105 of frypot 20 are shown. Lateral sides 105 each has two lateral ports 75, although a different number could be used depending upon size of fryer pot 20. Lateral ports 75 each receive clean oil from when valve 60 is opened and oil flows through tubing 65. Clean oil is distributed to lateral ports 75 from lateral manifolds 66. Each port 75 has a diverter 160 that is affixed to lateral wall 105 to deflect oil. Each diverter 160 is disposed inboard or interiorly of a respective lateral port 75 to deflect oil that is received from a lateral port 75. Similarly, each diverter 160 is disposed interiorly of frypot 20. As oil is sprayed from lateral ports 75, such oil strikes each diverter 160 at 90° angle. Clean oil is deflected in a downward direction to side walls 105. The direction of oil from lateral ports 150 is shown in FIG. 5 by arrows.

Referring to FIGS. 4 and 5, rear return 96 is shown. Rear return 96 is positioned at the lower back edge of frypot 20 on rear wall 115. Rear return 96 has a return valve 97 associated therewith that is selectively opened to permit clean filtered oil to spray from rear return 96 on to bottom 120 of frypot 20. Rear return 96 is positioned to spray clean oil and remove debris and sediment that has been washed toward bottom 120 by front diverters 125 and lateral diverters is 160. Clean oil is supplied to rear return 96 when controller 40 and MIB and AIF send signal to motor 99 that drives actuator 98 to open return valve 97.

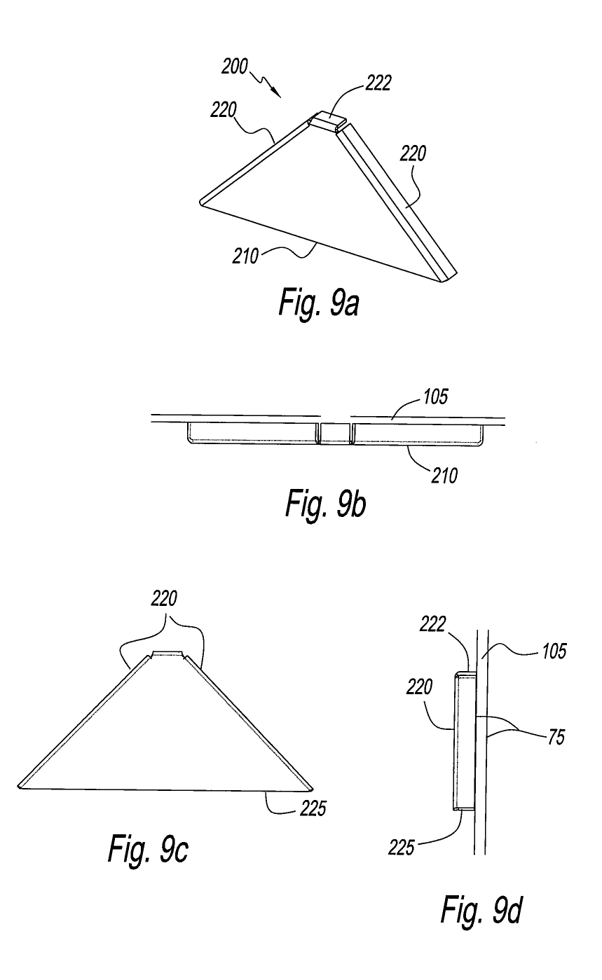

Referring to FIGS. 9a through 9d, a first configuration of a diverter is shown and generally referenced with reference numeral 200. Diverter 200 is trapezoidally shaped and is made from an easily bendable sheet metal such as aluminum. Diverter 200 is affixed to wall of deep fryer and is disposed proximate to and in front of a port in wall, such as a front wall 100 or a side wall 105 of fryer pot 20. A diverter 200 has a front plate 210, two angled sides 220, a lower edge 225 and a top side 222. Sides 220 and lower edge 225 have an angle from 45° to 50° therebetween. When oil flows through a port, for example, lateral port 75, such oil strikes front plate 210 at an angle of approximately 90° angle. Lower edge has a length of approximately 4.75 to 5.25 inches and a thickness of approximately 0.3 inches to 0.4 inches. Sides 220 ensure that oil is sprayed past edge 225 to have a spray pattern that will clean side walls 105. The spray of deflected oil will cover the wall to which it is affixed. Diverter 200 is attached to a front wall or side wall by soldering or any other effective means of affixing metals. FIG. 9d shows diverter affixed to a side wall 105 and an oil port 75. While diverter 200 has the above noted dimensions, other dimensions could also be used depending upon the size of the frypot.

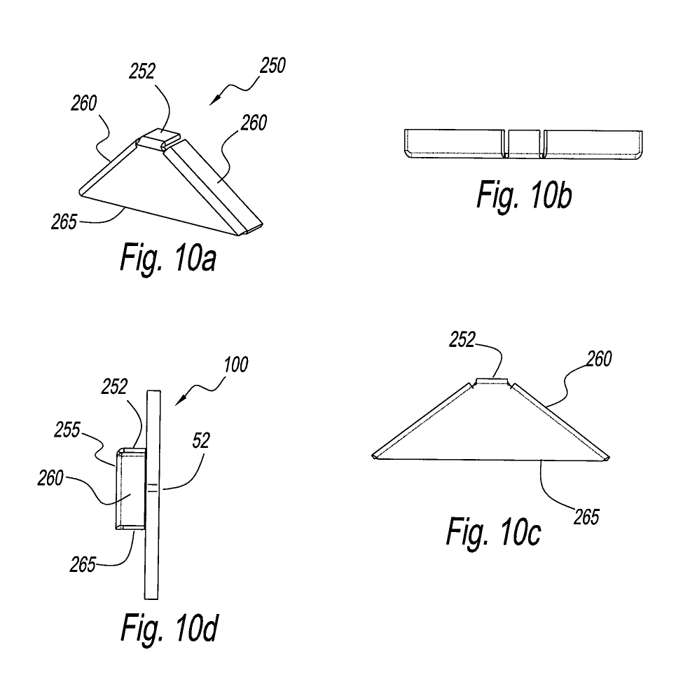

Referring to FIGS. 10a through 10d, a second configuration of a divereter 250 is shown. Diverter 250 has front 255, sides 260, a lower edge 265 and a top side 252. Sides 260 and lower edge 265 have an angle from 35° to 40° therebetween. When oil flows through a port, for example, front port 52, such oil strikes front plate 225 at an angle of approximately 90°. Lower edge 265 has a length of approximately 3.00 to 3.25 inches and a thickness of approximately 0.3 inches to 0.4 inches. Sides 260 ensure that oil is sprayed past edge 265 to have a spray pattern that will clean front walls 100, for example. The spray pattern will cover the wall to which it is affixed. FIG. 10d shows diverter affixed to a front wall 100 and an oil port 52. While diverter 250 has the above noted dimensions, other dimensions could also be used depending upon the size of the frypot.

In FIGS. 1 through 5, diverter 125 is sized as diverter 250 and is shown as being on front wall and diverter 160 is sized as diverter 200 and shown as being on side walls 105. However, other configurations or numbers of diverters could be used on walls 100 and 105 without departing from the inventive concept. For example, diverters could be triangularly shaped.

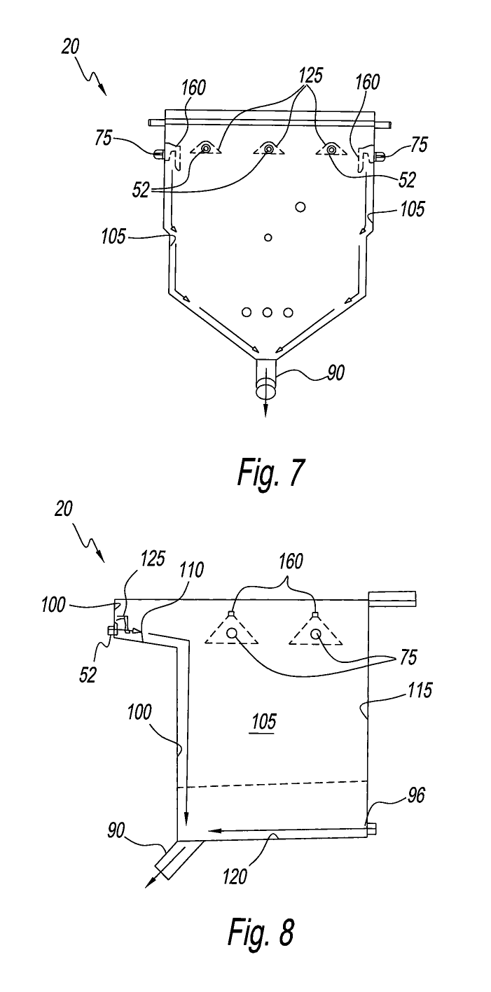

Referring to FIGS. 5 through 7, front ports 125, lateral ports 150 and rear return 170 each function together to provide optimal cleaning of front wall 10, foam deck 110, lateral sides 105, rear 115 and bottom 120 of frypot 20, respectively. The function of ports 52, 75 and 96, valves 42, 60 and 92, pump 80 are preferably coordinated by a controller 40 that is designed to monitor and manage the opening and closing of all valves, the pump to provide clean filtered oil in a sequential fashion to clean fryer pot. Controller 40 will be discussed further below.

Controller 40 allows filter cycles to be launched after a preprogrammed number of either product specific cook counts or a global deep fryer cook count in an automated mode. In this mode, the user is prompted to press a filtration switch or button on front panel 35. Alternatively, an operator can manual initiate a filtration cycle by using front panel 35.

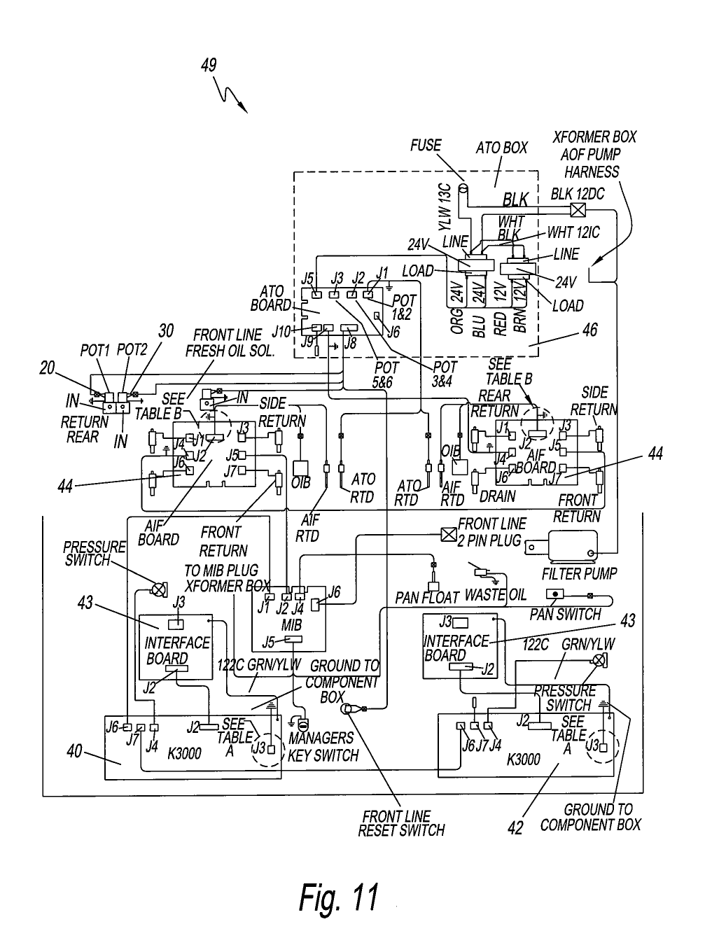

Referring to FIGS. 1 and 11, control system 49 includes a global controller 46 that controls filling functions of fryer pots 20 and 30. A requirement for filtration is provided from frypot controller 40 and 42. Each controller 40, 42 counts cook cycles for each fryer pot 20, 30 respectively and for total number of cook cycles. Operation of frypot 20 and controller 40 will be discussed for purposes of simplicity as both frypots and controllers operate in an identical fashion. Controller 40 includes memory, processor, software, for all filtration and oil management functions. Controller 40 has a processor that is used to execute the program that manages the sequential operation of all motors, valves associated with operation of frypot 20. Processor stores user programmed information that may be stored on a random access memory.

Controller 40 communicates with front panel 35 having a user interface to receive user inputted information. Controller 40 communicates with other components MIB 47, AIF 44 and interface board 43. MIB 47 communicates with AIF 44 to indicate filtration requirement and sends signal to AIF to accomplish such functions as drain fryer pot, opening a specific valve or closing a specific valve and AIF sends the signal to the motor to effect opening or closing of the valve. Accordingly, AIF 44 sends signals to motors 95, 99, 47 and 59 that together with actuators open or close valves 92, 97, 45 and 60, respectively. Interface board 43 manages the heating functions for fryer pot 20.

The washing sequence is described with reference to the figures using control system that includes controller 40, MIB and AIF. A filtration cycle begins either manually or automatically as discussed above and sends signal to MIB to commence cycle. MIB sends signal to AIF for drain valve 92 to be opened. AIF sends signal to motor 95 to drive actuator 85 to thereby open drain valve 9. MIB then sends signal to AIF for front valve 45 to be opened. AIF sends signal to motor 47 to drive actuator 49 to rotate and drive actuator 49 to open valve 45. Front valve 45 will permit oil to flow in tubing 50 once pump 80 is activated. MIB sends signal to AIF to energize pump motor 81 and pump 80. By activating pump 80, clean filtered oil is pumped through valve 45, front ports 52 to diverter 125 and down front wall 100 and front deck 110. Valve 45 remains opened for a pre-set length of time, for example, 10 seconds.

MIB sends signal to AIF to open side valve 66 to provide clean filtered oil through tubing 65 to side ports 75 for cleaning side walls 105. After side valve 66 is opened, MIB sends signal to AIF to close valve 45. AIF Sends signal to motor 47 to drive actuator 49 to close valve 45. After a pre-set length of time such as is 15 seconds, MIB sends signal to AIF to open rear return valve 97. AIF sends signal to motor 99 to rotate and drive actuator 98 to open rear return valve 97. By opening rear return valve 97, oil is able to wash sediment and debris accumulated from front wall 100, front deck 110 and side walls 105 out drain 90. After rear valve 97 is opened, MIB sends signal to AIF to close side valve 66. AIF sends signal to motor 59 to drive actuator 57 and thereby close side valve 66.

After a preset length of time, such as 20 seconds, MIB sends signal to AIF to close drain valve 92. Frypot 20 is washed and is ready to be filled. AIF sends signal to motor 95 to rotate and drive actuator 85 to close drain valve 92. Rear return valve 97 remains in an opened state for a preset length of time such as 25 seconds to fill fryer pot such that is approximately ⅔ filled. MIB sends signal to AIF to open side valve 60 so that remaining clean oil can be returned through lateral ports 75. AIF sends signal to motor 59 to rotate and drive actuator 57 to thereby open side valve 60. Side valve 60 remains opened for approximately 15 seconds or until frypot 20 is filled. By completely filling frypot using lateral ports 75 and not rear return 170, aeration of oil is prevented.

Alternatively, controller 40 (and 42) could each be configured to accomplish functions of MIB 47, AIF 44 and interface board 43 for fryer pot 20, and eliminate such separate components.

The washing sequence is described with reference to the figures. A filtration cycle begins either manually or automatically by controller 40 as discussed above. Controller sends signal to signal to motor 95 to drive actuator 85 to thereby open drain valve 9. Controller sends signal to motor 47 to drive actuator 49 to open front valve 45. Front valve 45 will permit oil to flow in tubing 50 once pump 80 is activated. Controller sends signal to energize pump motor 81 and pump 80. By activating pump 80, clean filtered oil from filter pan 70 is pumped through valve 45, front ports 52 to diverter 125 and down front wall 100 and front deck 110. Valve 45 remains opened for a preset length of time, for example, 10 seconds.

Controller 40 sends signal to motor 59 to drive actuator 57 to open side valve 60 to provide clean filtered oil through tubing 65 to side ports 75 for cleaning side walls 105. After side valve 60 is opened, controller 40 sends signal to motor 47 to close valve 45. After a preset length of time such as 15 seconds, controller sends signal to open rear return valve 97. Controller sends signal to motor 99 to rotate and drive actuator 98 to open rear return valve 97. By opening rear return valve 97, oil is able to wash sediment and debris accumulated from front wall 100, front deck 110 and side walls 105 out drain 90. After rear valve 97 is opened, controller 40 sends signal to motor 59 to close valve 60.

After a preset length of time, such as 20 seconds, controller sends signal to close drain valve 92. Frypot 20 is washed and is ready to be filled with clean oil. Controller 40 sends signal to motor 95 to rotate and drive actuator 85 to close drain valve 92. Rear return valve 97 remains in an opened state for a preset length of time such as 25 seconds to fill fryer pot such that is approximately ⅔ filled. Controller 40 sends signal to open side valve 60 so that remaining clean oil can be returned through lateral ports 75. Controller sends signal to motor 59 to rotate and drive actuator 57 to thereby open side valve 60. Side valve 60 remains opened for approximately 15 seconds or until frypot 20 is filled. By completely filling frypot using lateral ports 75 and not rear return 97, aeration of oil is prevented, thereby extending oil life.

The washing sequence is described with reference to the figures using control system that includes controller 40, MIB and AIF. A filtration cycle begins either manually or automatically as discussed above and sends signal to MIB to commence cycle. MIB sends signal to AIF for drain valve 92 to be opened. AIF sends signal to motor 95 to drive actuator 85 to thereby open drain valve 9. MIB then sends signal to AIF for front valve 45 to be opened. AIF sends signal to motor 47 to drive actuator 49 to rotate and drive actuator 49 to open valve 45. Front valve 45 will permit oil to flow in tubing 50 once pump 80 is activated. MIB sends signal to AIF to energize pump motor 81 and pump 80. By activating pump 80, clean filtered oil is pumped through valve 45, front ports 52 to diverter 125 and down front wall 100 and front deck 110. Valve 45 remains opened for a pre-set length of time, for example, 10 seconds.

MIB sends signal to AIF to open side valve 66 to provide clean filtered oil through tubing 65 to side ports 75 for cleaning side walls 105. After side valve 66 is opened, MIB sends signal to AIF to close valve 45. AIF Sends signal to motor 47 to drive actuator 49 to close valve 45. After a pre-set length of time such as 15 seconds, MIB sends signal to AIF to open rear return valve 97. AIF sends signal to motor 99 to rotate and drive actuator 98 to open rear return valve 97. By opening rear return valve 97, oil is able to wash sediment and debris accumulated from front wall 100, front deck 110 and side walls 105 out drain 90.

After rear valve 97 is opened, MIB sends signal to AIF to close side valve 66. AIF sends signal to motor 59 to drive actuator 57 and thereby close side valve 66.

After a preset length of time, such as 20 seconds, MIB sends signal to AIF to close drain valve 92. Frypot 20 is washed and is ready to be filled. AIF sends signal to motor 95 to rotate and drive actuator 85 to close drain valve 92. Rear return valve 97 remains in an opened state for a preset length of time such as 25 seconds to fill fryer pot such that is approximately ⅔ filled. MIB sends signal to AIF to open side valve 60 so that remaining clean oil can be returned through lateral ports 75. AIF sends signal to motor 59 to rotate and drive actuator 57 to thereby open side valve 60. Side valve 60 remains opened for approximately 15 seconds or until frypot 20 is filled. By completely filling frypot using lateral ports 75 and not rear return 170, aeration of oil is prevented.

Any alternative design that varies spray time lengths, valve opening sequencing, and/or the number of diverters or diverter geometry to more effectively clean a frypot is within the scope of the present disclosure. As such, modifications to spray time lengths and valve opening sequencing can be modified by preprogramming controller 40. Furthermore, all ports may be opened together to maximize cleaning of frypot 20.

The present disclosure has been described with particular reference to the preferred embodiment. It should be understood that the foregoing descriptions and examples are only illustrative of the present disclosure. Various alternatives and modifications thereof can be devised by those skilled in the art without departing from the spirit and scope of the present disclosure. Accordingly, the present invention is intended to embrace all such alternatives, modifications, and variations that fall within the scope of the present disclosure.

We claim:

1. A washing system for a deep fryer having a fryer pot comprising:
a pump,
a fryer pot comprising a wall and at least one port in said wall that is in fluid communication with said pump;
a valve in fluid communication with said at least one port and said pump;
a diverter affixed to said wall and disposed interiorly of said at least one port that deflects fluid projecting from said at least one port against said wall; and
a controller system that sends a signal to commence a filtration cycle to thereby open said valve and provide access to fluid from said pump through said at least one port to thereby clean a wall of said fryer pot.

2. The system according to claim 1, wherein said fryer pot further comprises four walls, and two of said four walls are opposed walls that each has at least one side port therein and a side diverter disposed proximate said port, and a side valve in fluid communication with said at side least one port on said opposed walls.

3. The system according to claim 2, wherein one of said four walls comprises a rear wall having a return port that is in fluid communication with a return valve that receives oil from said pump.

4. The system according to claim 1, wherein said at least one wall is a front wall comprising three ports, wherein each of said three ports has a diverter disposed proximate said port to deflect fluid from said port.

5. The system according to claim 1, wherein said diverter comprises two angled sides, a lower edge and a top side connected to a front side, wherein said front side has a trapezoidal shape.

6. The system of according to claim 5, wherein each of said angled sides has an angle of from 35° to 40° with said lower edge.

7. The system according to claim 2, wherein said side diverter comprises two angled sides, a lower edge and a top side connected to a front side, wherein said front side has a trapezoidal shape.

8. The system of according to claim 7, wherein each of said angled sides has an angle of from 45° to 50° with said lower edge.

9. The system according to claim 1, wherein said valve is a front valve.

10. The system according to claim 2, further comprising a fryer pot bottom, a drain in fluid communication with said fryer pot bottom and a drain valve.

11. The system according to claim 10, wherein said control system comprises a controller and a further comprises a filtration board that controls receives a signal from controller to commence a filtration cycle and an interface board that communicates with said filtration board to send signals to said valve, said side valve, said drain valve and said return valve to move between an opened position and a closed position in a predetermined sequence.

12. The system according to claim 10, wherein said control system comprises a controller that sends signals said valve, said side valve, said drain valve and said return valve to move between an opened position and a closed position in a predetermined sequence.

13. The system according to claim 10, further comprising conduits disposed between each said valve and said at least one port and said side valve and said at least one side port on each opposed side wall.

14. The system according to claim 10, wherein said valve, said side valve, said drain valve and said return valve each has a motor and an actuator to move said valve between an opened position and a closed position.

15. The system according to claim 1, wherein said diverter affixed to said wall has a triangular shape.

16. A washdown system for a fryer pot of a deep fryer comprising:
a fryer pot having four walls and a bottom and at least one port disposed on each of said four walls and said bottom for the passage of fluid;
a plurality of valves, wherein one of said plurality of valves is in fluid communication said at least one port of a wall or a bottom;
a pump that pumps oil through each of said plurality of valves to said ports; and
a control system that commences a wash cycle and thereby positions each of said plurality of valves in an opened position or a closed position to provide access of clean oil from said pump through said plurality of valves and said ports in a preprogrammed sequence to thereby clean a said walls of said fryer pot.

17. The system according to claim 16, wherein one of said four walls is a front wall that has at least two ports.

18. The system according to claim 17, wherein said front wall has two diverters and one of said diverters is disposed across one of said at least two ports to deflect oil and another of said at least two diverters is disposed across the other of said at least two ports to deflect oil therefrom.

19. The system according to claim 16, wherein two of said four walls are side walls that each has at least two ports.

20. The system according to claim 17, wherein each of said two side walls has a two diverters that are each disposed over a port to deflect oil therefrom.

21. The system according to claim 16, wherein one of said walls is a rear wall that has a return port disposed proximate said bottom wall in fluid communication with a return valve.

22. The system according to claim 16, wherein said bottom has a drain in fluid communication with a drain valve.

23. The system according to claim 16, wherein each of said plurality of valves has a motor and an actuator, wherein said motor is in electrical communication with said interface board.

24. The system according to claim 16, wherein said control system comprises a controller that sends a signal to open said drain valve for a preset length of time commence filtration and communicate with each of said plurality of valves in a sequential fashion to place such valves in an opened position or a closed position.

25. A method of washing a fryer pot of a deep fryer, the fryer pot having four walls and a bottom, a pump a drain, a drain valve, a motor for placing the drain valve in an opened position or a closed position, a return port, a return valve and a motor for placing the return valve in an opened or closed position, the method comprising:
a) providing a fryer pot, wherein two of the four walls are opposed side walls each having at least one side port and a side valve in fluid communication with said side port, and one of said walls is a front wall that has at least one port and a valve in fluid communication with said front port;
b) opening the drain valve for a preset length of time;
c) opening one of said front valve or said side valve for a preset length of time;
d) providing oil through one of said front valve or said side valve;
e) closing one of said front valve or said side valve; and
f) closing the drain valve to fill the fryer pot.

26. The method according to claim 25, wherein step c) further comprises opening said front valve for a preset length of time.

27. The method according to claim 25, wherein step e) further comprises closing said front valve and opening said side valve for a preset length of time and then closing said side valve.

28. The method according to claim 25, wherein before step f) said returned valve is opened to clean a the bottom of fryer pot.

29. The method according to claim 25, wherein the opening and closing the drain valve, said front valve, said side valve and the return valve comprise sending a signal to a motor in electrical communication with each said valve and driving an actuator to open or close each said valve.

30. The method according to claim 25, wherein a controller provides signals to each of said drain valve, said front valve, said side valve and said return valve to open and close in a predetermined sequence.

31. The method according to claim 25, wherein each of said side ports and said front ports has a diverter located over said port to deflect oil against the side wall or the front wall.
